(19) United States
(12) Patent Application Publication
(10) Pub. No.: US 2003/0158907 A1
(43) Pub. Date: Aug. 21, 2003

(54) Network announcement platform

(76) Inventor: Hamid Reza Zarafshar, Wayne, IL (US)

Correspondence Address: Docket Administrator (Room 3J-219), Lucent Technologies Inc., 101 Crawfords Corner Road, Holmdel, NJ, 07733-3030, US

(21) Appl. No.: 10/060,596

(22) Filed: Jan. 30, 2002

(51) Int. Cl. G06F 15/16

(52) U.S. Cl. 709/213; 709/250; 709/207

(57) ABSTRACT

Network announcements are cached on an announcement card, so that the phonemes do not have to be read from disk every time an announcement is needed. Memory is provided on the announcement card to hold the phonemes of announcements are they are used by the announcement system. A suitable caching algorithm is used to replace stored announcements with other announcements as needed. Each announcement card stores its own set of announcements, which may or may not be the same as another announcement card. Thus, on the average, announcements may be more readily available, increasing the speed and capacity of the network announcement system without major modification.

### FIELD OF THE INVENTION

This invention relates to announcements in telephone networks, and, more specifically, to an announcement platform usable in an intelligent network that caches speech data to facilitate efficient handling of common announcements.

### BACKGROUND OF THE INVENTION

Telephone companies use digitized speech for common announcements, such as “please deposit X cents” and “the number you have dialed, NXX-XXXX, is not in service”. Digitized speech permits the telephone companies to store each phoneme once, then assemble the string of phonemes that comprise the announcement. Such digitized speech was a big cost savings over playback of an entire announcement from magnetic tape or similar media or using a live operator.

To play digitized a speech as announcement, a processor determines an announcement that is required for a specific situation. A database (which is stored on a disk storage system) is accessed for the string of phonemes required for the announcement. Each phoneme is read from the disk storage and loaded onto a card connected to the network. The card assembles the digitized phonemes and converts them to analog speech signals out to the network connection.

### SUMMARY OF THE INVENTION

The present invention provides a network announcement platform that avoids some of the costs and disadvantages of the prior art. In particular, the illustrative embodiment of the present invention enables network announcements to be cached on an announcement card, so that the phonemes do not have to be read from disk every time an announcement is required. Memory is provided on the announcement card to hold the phonemes of announcements after they are used by the announcement platform for the first time. A suitable caching algorithm is used to replace stored announcements with other announcements as needed.

A network announcement platform may comprise a plurality of announcement cards, wherein each announcement card stores its own set of announcements, which may or may not be the same as another announcement card. Thus, on the average, common announcements are more readily available, increasing the speed and capacity of the network announcement platform without major modification.

### BRIEF DESCRIPTION OF THE DRAWINGS

A more complete understanding of this invention may be obtained from a consideration of the following description, taken in conjunction with the drawings, in which:

FIG. 1 is a block diagram of a network announcement platform in the context of an intelligent telephone network according to one aspect of this invention;

FIG. 2 is a block diagram of an announcement card of FIG. 1 according to an exemplary embodiment of this invention; and

FIG. 3 is a flow chart of processing of the announcement card of FIG. 2 according to an exemplary embodiment of this invention.

### DETAILED DESCRIPTION

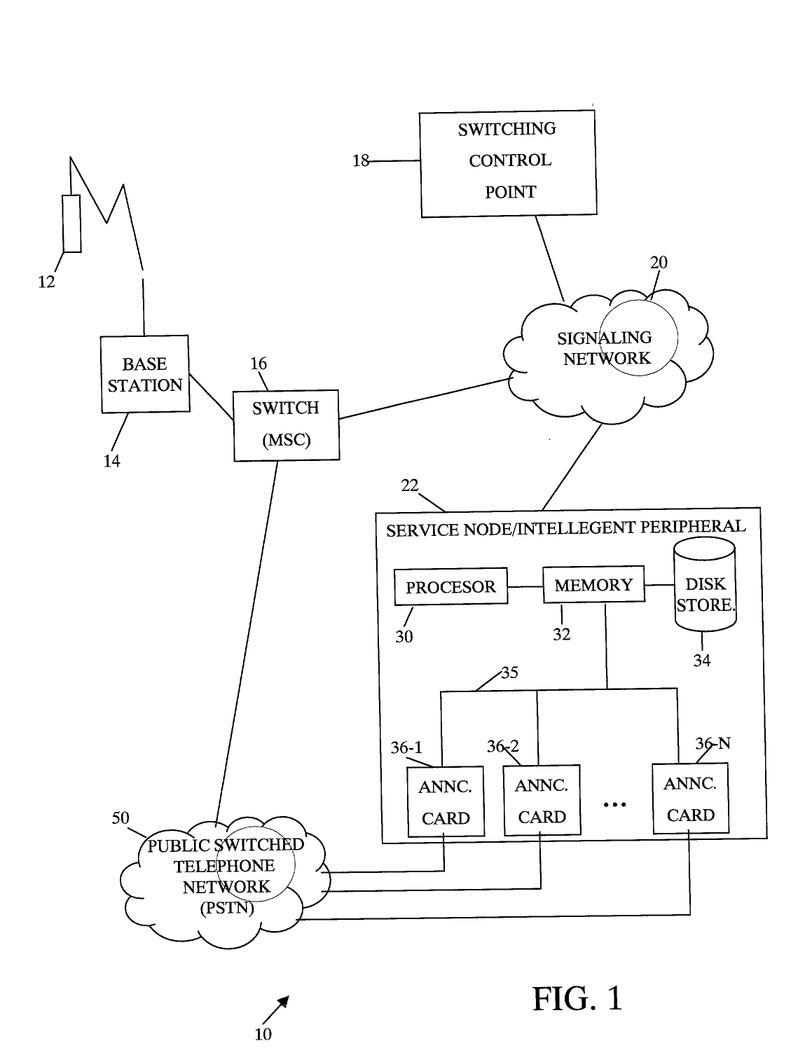

FIG. 1 is a block diagram of an intelligent telephone network 10, in which an exemplary embodiment of this invention may function. This invention will be described herein in the context of a prepaid wireless service, but the applicability of the invention is much broader, as will be appreciated by one skilled in the art after studying this specification. In prepaid wireless, a customer at wireless telephone 12 enters a destination telephone number and presses the “send” button. A cell site 14 receives the call request messages and initiates call set up to mobile switching center (MSC) 16, as according to the known art.

MSC 16 determines that this call is a prepaid call. In response, MSC 16 contacts switching control point (SCP) 18 through signaling network 20 for instructions. Among the actions performed by SCP 18, SCP 18 determines the amount of prepaid time remaining in the account of wireless telephone 12 (four and a half minutes, for example). SCP 18 then causes a service node or intelligent peripheral (herein “SN”) 22 to announce the amount of time left in the account to the customer at wireless telephone 12.

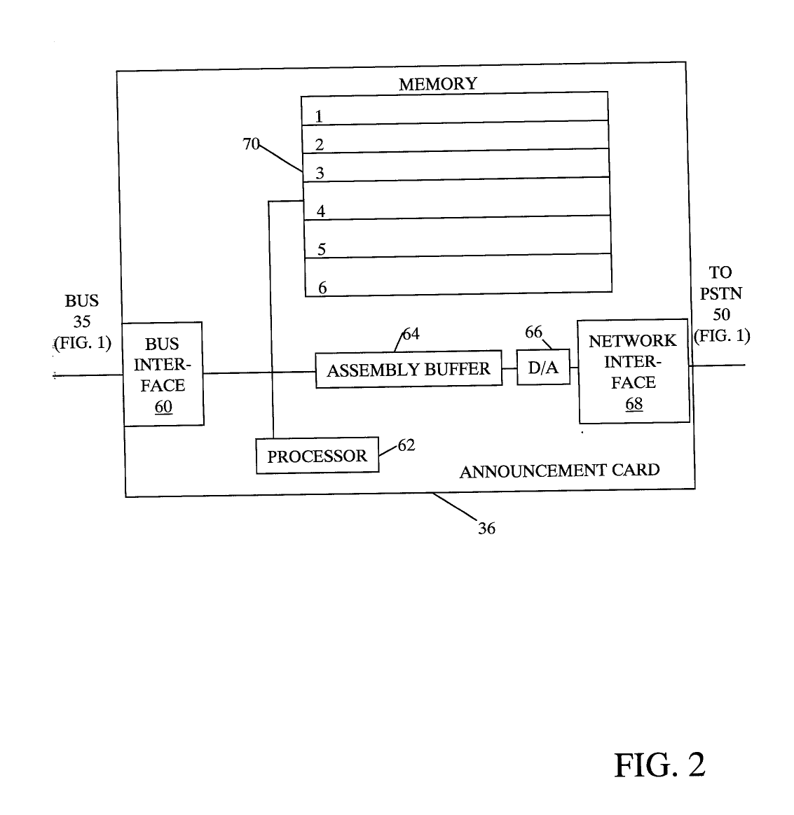

SN 12, in this exemplary embodiment, comprises an announcement platform according to this invention. SN 12 comprises a processor 30, memory 32 and long term storage in the form of disk storage system 34 interconnected by bus 35, as is commonly practiced in the art. SN 12 also includes a plurality of announcement cards 36, represented by announcement cards 36-1 through 36-N, also connected to bus 35, according to this exemplary embodiment of this invention. To make the announcement to the prepaid wireless customer that he or she has four and a half minutes left in the prepaid account, processor 30 selects an idle announcement card, for example announcement card 36-2. According to the prior art, announcement card 36-2 requests processor 30 to retrieve the announcement phonemes from disk storage 34 and read the phonemes into memory 32. Processor 30 then causes the announcement phonemes to be transferred to announcement card 36-2, where they are assembled and converted into speech (as is known in the art and will be discussed further, below, in connection with FIG. 2).

While SN 12 is processing the announcement, a call is set up from the announcement card 36-2 through the public switched telephone network (PSTN) 50, MSC 16, cell site 14 to wireless telephone 12. Then announcement is then converted into speech and delivered as analog signals over the voice path to the user of wireless telephone 12. The call is then torn down and announcement card 36-2 is idled. The announcement in the assembly buffer is either removed or replaced by the next announcement.

In contradistinction to the prior art, an advancement is made in the art by a system and method that, instead of the announcement card 36 being idled immediately, announcement card 36 stores the announcement according to a caching algorithm in memory on the announcement card. When processor 30 assigns an announcement card 36, such as announcement card 36-2 to a particular transaction according to the above scenario, announcement card 36-2 first determines whether the requisite announcement is stored in its on-board memory. If the announcement is already stored, then the steps of reading the phonemes from disk into memory and from memory into the announcement card are eliminated, thus saving time and increasing capacity of the entire system.

FIG. 2 illustrates a block diagram of an announcement card 36 according to an exemplary embodiment of this invention. Announcement card 36 includes a bus interface 60, which connects announcement card 36 to bus 35 of SN 22 (FIG. 1). Bus interface 60 is connected to processor 62 and assembly buffer 64, as is known in the art. Phonemes to be delivered to a caller as an announcement are assembled in order in assembly buffer 64 and converted to sounds in digital-to-analog converter 66. The sounds (words) are then delivered through a network interface 68 into the PSTN 50 (FIG. 1).

Announcement card 36 also includes memory 70. Memory 70 is used, according to an exemplary embodiment of this invention, to store announcements. Advantageously, stored announcements are in proper phoneme order for the message to save further time when they are read into assembly buffer 64. After an announcement is delivered to the D/A converter 66, processor 62 determines whether this announcement should be stored in memory 70. In the example of FIG. 2, memory 70 stores six different announcements. Of course, more or fewer announcements may be stored in memory 70, depending on the size of the memory and the storage algorithm used by processor 62 to store announcements in memory 70.

According to this exemplary embodiment of this invention, after processor 62 receives notification of which announcement to play, it first checks its cache. If the announcement is in cache, then the announcement is copied into the assembly buffer 64, converted to analog, etc. If the announcement is not in the cache, then processor 62 requests the phonemes that make up the announcement from disk storage 34 (FIG. 1). Processor 62 then decides whether to store the current announcement or not. Any caching algorithm may be used for this purpose. For example, processor 62 may keep a count of the number of times that each announcement is requested, and keep the most requested announcements in cache. Other algorithms may be used without departing from the scope of this invention.

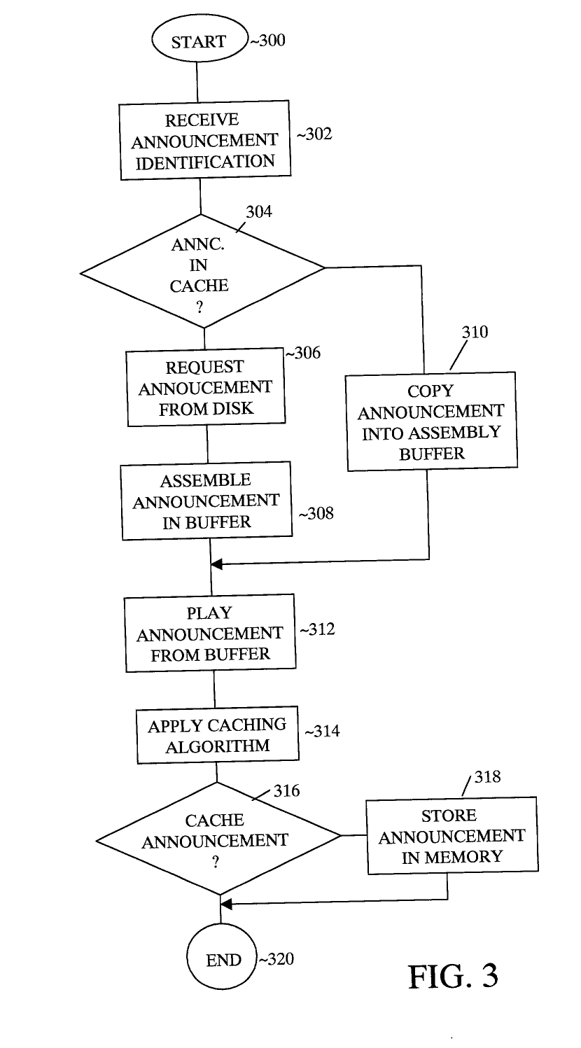

Turning now to FIG. 3, operation of announcement card 36 is shown, according to one aspect of this invention. Processing starts in circle 300 and moves to action box 302, where the identification of an announcement to be played is received. In decision diamond 304, a determination is made whether the announcement is in cache. If it is not, then processor 62 requests the message from disk storage 34 in action box 306. Processing proceeds to action box 308, where the phonemes are received and assembled.

If, in decision diamond 304, the announcement is determined to be in cache, it is copied into the assembly buffer in action box 310. Processing from action boxes 308 and 310 continues to action box 312, where the announcement is played. In action box 314, the processor applies the cashing algorithm to the announcement. A determination is made in decision diamond 316 whether the caching algorithm indicated that the announcement should be stored. If so, then the announcement is stored in action box 318. Processing ends in circle 320.

It is to be understood that the above-described embodiments are merely illustrative of the principles of the invention and that many variations may be devised by those skilled in the art without departing from the scope of the invention. For example, certain messages may be “locked” in cache if they are used frequently. Furthermore, the terms “announcement” and “phonemes” are not to be defined strictly as common telephone network announcements that comprise phonemes of words. An “announcement” may be a traffic or weather announcement. Further, an “announcement” may comprise music wherein the “phonemes” are digitized sounds. An “announcement” may also comprise data to be displayed, wherein the “phonemes” are the digital data that comprise the data message. It is, therefore, intended that such variations be included within the scope of the appended claims.

What is claimed is:

1. A network announcement platform comprising:
a processor;
a disk drive storing phonemes that form a plurality of network announcements;
a memory; and
a plurality of announcement cards, each of said announcement cards including a memory for caching announcements.

2. A network announcement platform in accordance with claim 1 wherein each of said plurality of announcement cards includes a processor configured to execute a cashing algorithm as announcements are played.

3. A network announcement platform in accordance with claim 1 wherein each of said plurality of announcement cards includes a processor configured to request an announcement from said processor when said announcement is not in said memory for caching announcements.

4. A network announcement platform in accordance with claim 1 wherein announcements are stored in phoneme order in said memory for caching announcements.

5. A method for operating a network announcement platform comprising a processor, a disk drive storing phonemes that form a plurality of network announcements, a memory; and a plurality of announcement cards, each of said announcement cards including a memory for caching announcements, said method comprising the steps of:
receiving a request for an announcement;
assigning an announcement card to said request;
determining whether said announcement is in said memory by said announcement card: and
delivering said announcement from said memory by said announcement card.

6. A method in accordance with claim 5 further including the step of:
if said announcement is not in said memory, said announcement card requesting phonemes that comprise said announcement from said processor.

7. A method in accordance with claim 6 further including the step of:
said processor reading said phonemes from said disk drive into said memory and from said memory to said announcement card.
